(19) United States
(12) Patent Application Publication
(10) Pub. No.: US 2022/0190991 A1
(43) Pub. Date: Jun. 16, 2022

(54) FAST CHANNEL STATE INFORMATION DURING NEW RADIO SECONDARY CELL ACTIVATION

(71) Applicant: Telefonaktiebolaget LM Ericsson (publ), Stockholm (SE)

(72) Inventors: Ajit NIMBALKER, Fremont, CA (US); Ravikiran NORY, San Jose, CA (US); Stephen GRANT, Pleasanton, CA (US)

(21) Appl. No.: 17/442,426

(22) PCT Filed: Mar. 27, 2020
(86) PCT No.: PCT/EP2020/058783

§ 371 Date: Sep. 23, 2021

Related U.S. Application Data
(60) Provisional application No. 62/826,604, filed on Mar. 29, 2019.

(51) Int. Cl. H04L 5/00

(52) U.S. Cl. CPC H04L 5/0053

(57) ABSTRACT

A method, network node and wireless device for Scell activation/deactivation are disclosed. According to one aspect, a method includes determining if a serving cell of a wireless device (WD) is activated. The method further includes causing transmission of at least one medium access control (MAC) control element (CE) to deactivate a first semi-persistent channel state information (CSI) resource and a first semi-persistent (SP) CSI reporting configuration.

### FIELD

The present disclosure relates to wireless communications, and in particular, to fast channel state information during New Radio (NR) secondary cell (Scell) activation.

### BACKGROUND

Carrier aggregation is generally used in NR (New Radio or Fifth Generation (5G)) and Long Term Evolution (LTE) systems to help improve wireless device (WD) transmit and receive data rates. With carrier aggregation (CA), the WD typically operates initially on a single serving cell called a primary cell (Pcell). The Pcell is operated on a component carrier in a frequency band. The WD is then configured by the network with one or more secondary serving cells (Scells). Each Scell can correspond to a component carrier (CC) in the same frequency band (intra-band CA) as the frequency band of the CC of the Pcell (inter-band CA) or in a frequency band that is different from the frequency band of the CC of the Pcell. For the WD to transmit/receive data on the Scells, e.g., by receiving downlink shared channel (DL-SCH) information on a physical downlink shared channel (PDSCH) or by transmitting uplink (UL)-SCH information on a physical uplink shared channel (PUSCH), the Scells may need to be activated by the network. The Scells can also be deactivated and later reactivated as needed via activation/deactivation signaling.

Typically, the activation procedure can take anywhere between a minimum activation delay (on order of a few milliseconds) to up to multiples of 10s of milliseconds. The network may not know on a very fine time scale when the WD has become activated unless the network can configure channel quality information (CQI) with very fast frequency and use the reported CQI from the WD whether it is activated or not. This feature is enabled in LTE evolved carrier aggregation (eCA) with the mechanism described below.

In LTE eCA, a fast CQI reporting mechanism is specified during the CA activation procedure to enable the network, i.e., the network node, to determine when the WD is activated and ready to receive control information and data on a much finer time scale compared to other systems. To achieve this, the network enables very frequent CQI reporting for the corresponding Scell. Typically, a WD would report an out-of-range value for CQI when it is not yet activated, and a valid CQI when it is activated. Once the network node determines that the WD has reported a valid CQI, the network node can assume the WD is activated and is ready to monitor control information and also ready to start receiving data. The CQI could be used for scheduling as well.

In LTE, a faster CQI configuration is enabled for a fixed amount of time, i.e., from subframe n+8 to subframe n+34, where n is a subframe in which the medium access control (MAC) Scell activation command is received by the WD.

Reusing LTE methods for fast CQI for Scell activation may not work for NR since LTE uses a fixed period of 20 ms for fast CQI configuration. The minimum and maximum activation times allowed in NR may vary with larger range and hence using a fixed value (like in LTE) for NR fast channel state information (CSI) for Scell activation may increase network overhead and WD power consumption.

### SUMMARY

Some embodiments advantageously provide methods, network nodes and wireless devices for fast channel state information during New Radio (NR) secondary cell (Scell) activation.

Some embodiments provide enhanced mechanisms for a fast CSI reporting operation during (or at) Scell activation to enable the network to determine that the WD has activated on a much faster scale. One or more embodiments may be implemented by introducing a semi-persistent CSI resource configuration and a semi-persistent CSI reporting configuration, which are implicitly triggered along with the medium access control (MAC) command used for Scell activation. This implicit triggering can reduce network overhead since no separate MAC commands for activating these semi-persistent configurations are used. This creates a more efficient fast CSI reporting mechanism for NR Scell activation. Once the network determines the Scell is activated, the network can deactivate the semi-persistent configurations using an explicit MAC command and/or via a deactivation timer. The deactivation timer can also be configured by the network wherein the timer can be selected from one of a plurality of timer values. The timer values can be based on synchronization measurement timing configuration (SMTC) periodicity.

According to one aspect, a network node configured to communicate with a wireless device, WD, is provided. The network node is configured to determine if a serving cell of the WD is activated. The network node is also configured to, when the serving cell of the WD is activated, transmit at least one medium access control, MAC, control element, CE, to deactivate a first semi-persistent, SP, channel state information reference signal, CSI-RS, resource configuration and a first SP channel state information, CSI, reporting configuration.

According to this aspect, in some embodiments, the first SP CSI resource configuration and first SP CSI reporting configuration are configured by the WD in response to at least one MAC CE different from the at least one MAC CE used to deactivate the first SP CSI-RS resource configuration and the SP CSI reporting configuration. In some embodiments, the network node is further configured to activate a second SP CSI resource configuration and a second CSI reporting configuration. In some embodiments, the network node is further configured to trigger a CSI resource or tracking reference signal. In some embodiments, the network node is configured to transmit an activation command to the WD, the WD being configured with multiple sets of CSI-RS, resource configurations and multiple sets of CSI reporting configurations, and the activation command specifying one of the multiple sets of CSI-RS resource configurations and one of the multiple sets of CSI reporting configurations. In some embodiments, the activation command triggers a CSI resource for tracking. In some embodiments, the activation command triggers the first CSI-RS resource configuration and the first CSI reporting configuration, implicitly. In some embodiments, the network node is configured, upon activation, to use a first scheduling procedure to schedule at least an additional CSI-RS resource configuration and a CSI reporting configuration different from the first CSI-RS resource configuration and first CSI reporting configuration.

According to another aspect, a method implemented in a network node includes determining if a serving cell of the WD is activated, and when the service cell of the WD is activated, transmitting at least one medium access control, MAC, control element, CE, to deactivate a first semi-persistent, SP, channel state information reference signal, CSI-RS, resource configuration and a first SP CSI reporting configuration.

According to this aspect, in some embodiments, the first SP CSI resource configuration and first SP CSI reporting configuration are configured by the WD in response to the at least one MAC CE different from the at least one MAC CE used to deactivate the first SP CSI-RS resource configuration and the SP CSI reporting configuration. In some embodiments, the method further includes activating a second CSI-RS resource configuration and a second CSI reporting configuration. In some embodiments, the method further includes triggering a CSI resource or tracking reference signal. In some embodiments, the method further includes transmitting an activation command to the WD, the WD being configured with multiple sets of CSI-RS, resource configurations and multiple sets of CSI reporting configurations, and the activation command specifying one of the multiple sets of CSI-RS resource configurations and one of the multiple sets of CSI reporting configurations. In some embodiments, the activation command triggers a CSI resource for tracking. In some embodiments, the activation command triggers the first CSI-RS resource configuration and the first CSI reporting configuration, implicitly. In some embodiments, the method further includes using a first scheduling procedure to schedule at least an additional CSI-RS resource configuration and a CSI reporting configuration different from the first CSI-RS resource configuration and first CSI reporting configuration, respectively.

According to yet another aspect, a WD configured to communicate with a network node is provided. The WD is configured to receive at least one medium access control, MAC, control element, CE, from the network node to activate a first semi-persistent channel state information reference signal, SP CSI-RS, resource configuration and a first SP channel state information, CSI, reporting configuration. The WD is also configured to cause transmission of a valid CSI based at least in part on a configured CSI resource and report responsive to the at least one MAC CE.

According to this aspect, in some embodiments, the WD is further configured to receive a MAC CE indicating deactivation of the first SP CSI-RS resource and the SP CSI reporting configuration. In some embodiments, the WD is further configured to deactivate the first SP CSI-RS resource and the first SP CSI reporting configuration upon receiving the MAC CE indicating deactivation. In some embodiments, the WD is further configured to implement a deactivation timer to deactivate the first SP CSI-RS resource configuration and the first SP CSI reporting configuration when the deactivation timer expires. In some embodiments, deactivation occurs if a deactivation command is received from the network node when the deactivation timer has not expired.

According to yet another aspect, a method implemented in a wireless device (WD) includes receiving at least one medium access control, MAC, control element, CE, from the network node to activate a first semi-persistent channel state information reference signal, SP CSI-RS, resource configuration and a first SP channel state information, CSI, reporting configuration. The method also includes causing transmission of a valid CSI based at least in part on a configured CSI resource and report responsive to the at least one MAC CE.

According to this aspect, in some embodiments, the method further includes receiving a MAC CE indicating deactivation of the first CSI resource and the SP CSI reporting configuration. In some embodiments, the method includes deactivating the first CSI resource and reporting configuration upon receiving the MAC CE indicating deactivation. In some embodiments, the method includes implementing a deactivation timer to deactivate the first SP CSI-RS resource configuration and the first SP CSI reporting configuration when the deactivation timer expires. In some embodiments, deactivation occurs if a deactivation command is received from the network node when the deactivation timer has not expired.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node for fast channel state information during New Radio (NR) secondary cell (Scell) activation’

FIG. 8 is a flowchart of an alternative exemplary process in a network node for fast CSI during NR Scell activation;

FIG. 9 is a flowchart of an exemplary process in a wireless device for fast channel state information during New Radio (NR) secondary cell (Scell) activation;

FIG. 10 is a flowchart of an exemplary process in a wireless device for fast CSI during NR Scell activation;

FIG. 11 is a diagram of a first solution for Scell activation;

FIG. 12 is a diagram of a second solution for Scell activation;

FIG. 13 is a diagram of a third solution for Scell activation; and

FIG. 14 is diagram of yet another solution for Scell activation.

### DETAILED DESCRIPTION

Before describing in detail exemplary embodiments, it is noted that the embodiments reside primarily in combinations of apparatus components and processing steps related to fast channel state information during New Radio (NR) secondary cell (Scell) activation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments enable the network to efficiently figure out when the WD activates its Scell on a much finer and faster time scale than existing systems, which in turn improves network performance as it can make use of an Scell for scheduling data to the WD earlier. From the WD perspective, since the network can make use of the Scell for scheduling data on a faster timescale to that WD, an improved user experience may be achieved, e.g., through higher data rates or lower latency in file downloads, etc.

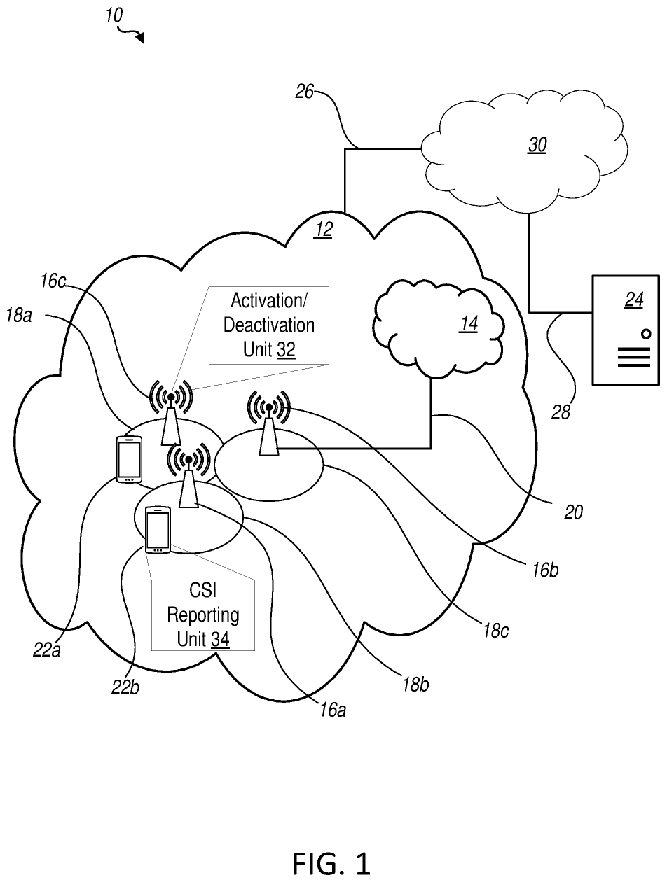

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. In one or more embodiments, one or more Pcells and/or one or more Scells may be provided by one or more network nodes.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an activation/deactivation unit 32 which is configured to activate/deactivate semi-persistent CSI. A wireless device 22 is configured to include a CSI reporting unit 34 which is configured to report CSI to the network node 16.

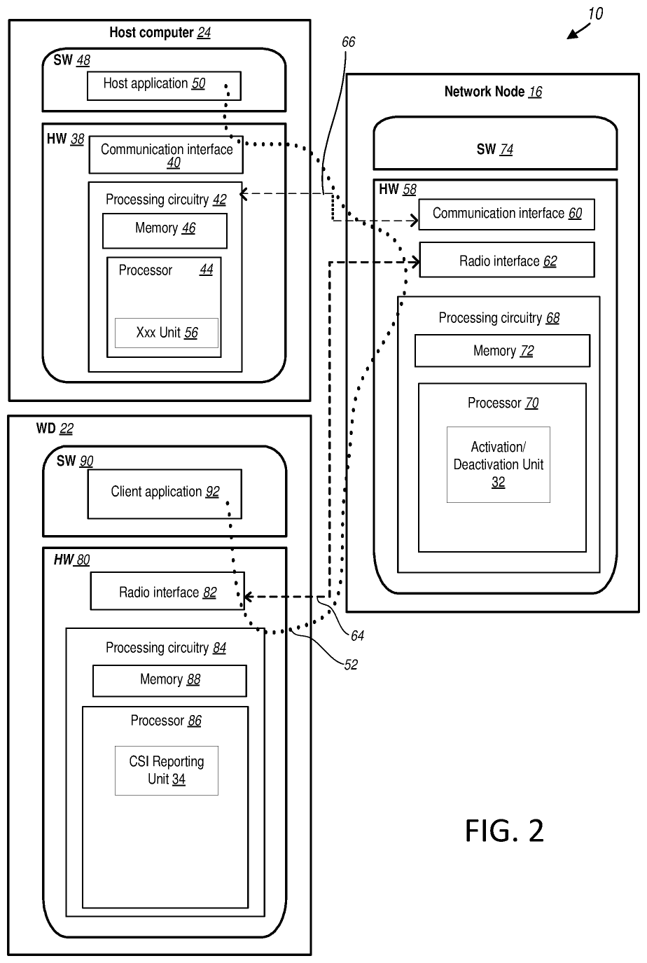

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an activation/deactivation unit 32 which is configured to activate/deactivate semi-persistent CSI.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a CSI reporting unit 34 which is configured to report CSI to the network node 16.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as activation/deactivation unit 32, and CSI reporting unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

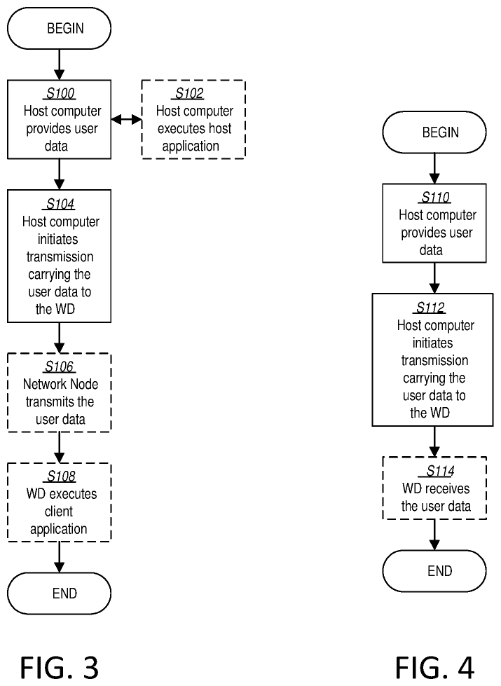

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

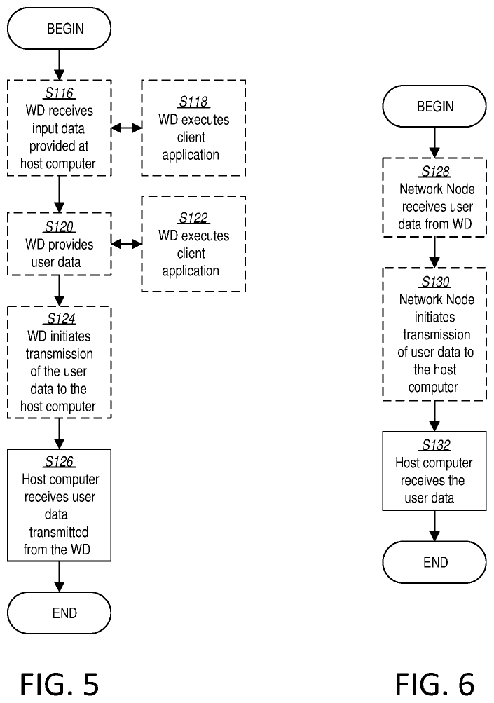

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

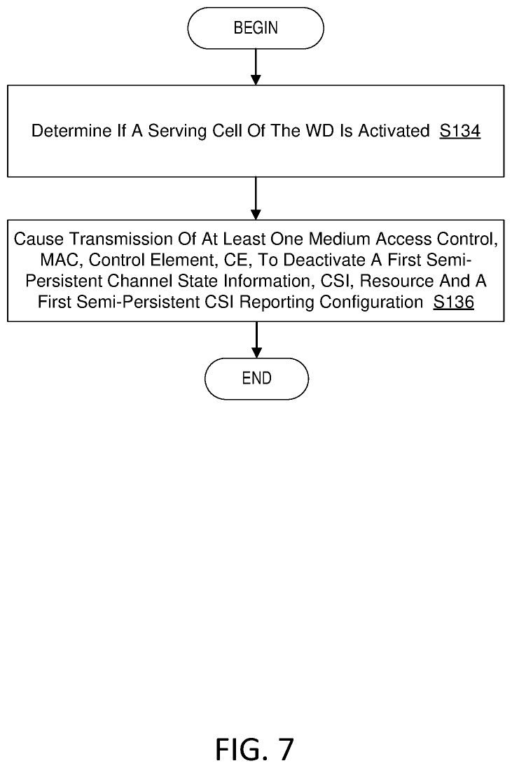

FIG. 7 is a flowchart of an exemplary process in a network node 16 for fast channel state information during New Radio (NR) secondary cell (Scell) activation according to principles set forth herein. One or more blocks described herein may be performed by one or more elements of network node 16 such as by one or more of processing circuitry 68 (including the activation/deactivation unit 32), processor 70, radio interface 62 and/or communication interface 60. Network node 16 such as via processing circuitry 68 and/or processor 70 and/or radio interface 62 and/or communication interface 60 is configured to determine if a serving cell of the WD is activated (Block S134). The process further includes sending at least one medium access control, MAC, control element, CE, to deactivate a first semi-persistent channel state information, CSI, resource and a first semi-persistent CSI reporting configuration (Block S136).

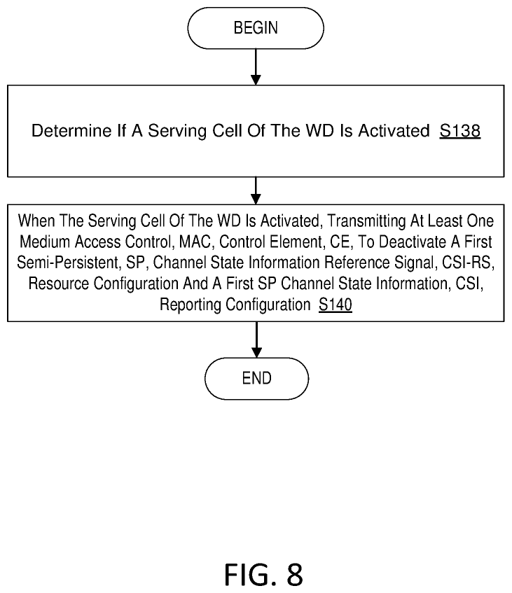

FIG. 8 is a flowchart of an alternative exemplary process in a network node 16 for fast CSI during NR Scell activation according to principles set forth herein. The network node 16, radio interface 62 and/or processing circuitry 68 (including the activation/deactivation unit 32) may be configured to determine if a serving cell of the WD is activated (Block S138). The process also includes, when the serving cell of the WD is activated, transmitting at least one MAC CE to deactivate a first SP CSI-RS, resource configuration and a first SP CSI, reporting configuration (Block S140).

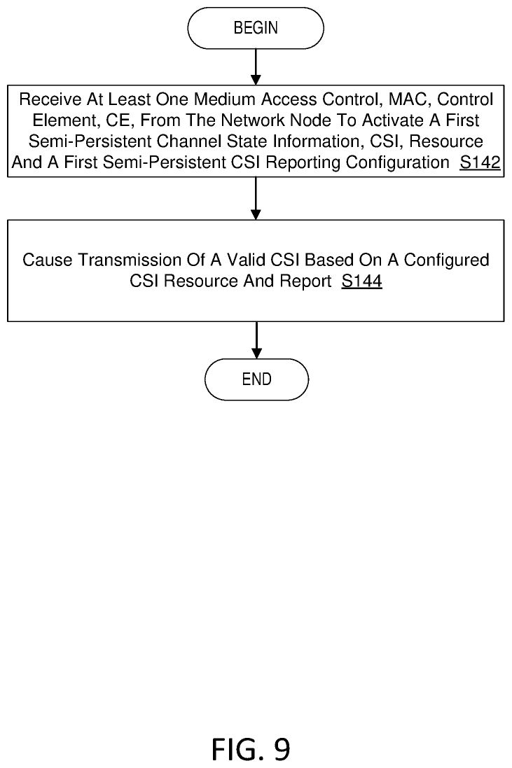

FIG. 9 is a flowchart of an exemplary process in a wireless device 22 according to some embodiments of the present disclosure. One or more blocks described herein may be performed by one or more elements of wireless device 22 such as by one or more of processing circuitry 84 (including the CSI reporting unit 34), processor 86, radio interface 82 and/or communication interface 60. Wireless device 22 such as via processing circuitry 84 and/or processor 86 and/or radio interface 82 is configured to receive at least one medium access control, MAC, control element, CE, from the network node to activate a first semi-persistent channel state information, CSI, resource and a first semi-persistent CSI reporting configuration; (Block S142). The process also includes sending a valid CSI based on a configured CSI resource and report (Block S144).

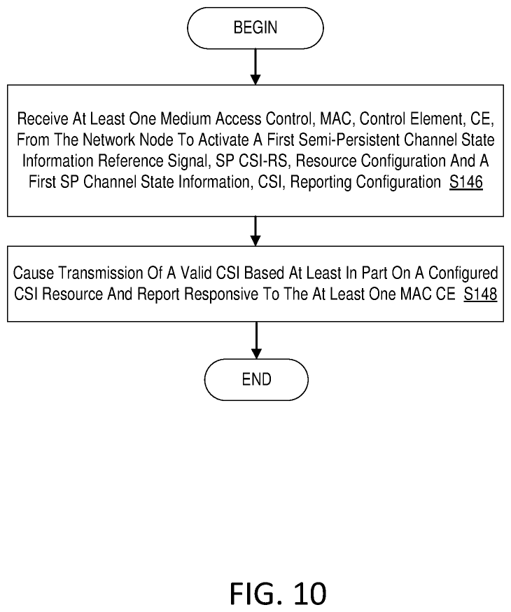

FIG. 10 is a flowchart of an alternative exemplary process in a wireless device 22 according to some embodiments of the present disclosure. The WD 22, radio interface 82 and/or processing circuitry 84 (including the CSI reporting unit 34) may be configured to receive at least one MAC CE from the network node 16 to activate a first SP CSI-RS, resource configuration and a first SP CSI, reporting configuration (Block S146). The process also includes causing transmission of a valid CSI based at least in part on a configured CSI resource and report responsive to the at least one MAC CE (Block S148).

Having described the general process flow of arrangements of the disclosure and having provided examples of hardware and software arrangements for implementing the processes and functions of the disclosure, the sections below provide details and examples of arrangements for fast channel state information during New Radio (NR) secondary cell (Scell) activation.

Some embodiments temporarily configure CSI resources for measurement and reporting during the Scell activation procedure. This allows the network node 16, such as a base station (gNb), to get a faster indication from the WD 22 about activation and to make use of the Scell on a faster timescale, thereby improving throughput and overall system performance.

The WD 22 is configured, via the activation/deactivation unit 32 and radio interface 62, with multiple sets of channel state information reference signal (CSI-RS) resource configurations and multiple sets of CSI reporting configurations for a serving cell. The WD 22 receives, via radio interface 82, an activation command from the radio interface 62 of the network node 16, activating the serving cell such as by an activation MAC command control element (CE). On reception of an activation command, a first set of CSI-RS resource configurations and a first set of CSI reporting configurations are implicitly activated. The WD 22 can use CSI-RS transmissions according to the first set of CSI-RS resource configurations and report, via the CSI reporting unit 34, CSI according to the first set of CSI reporting configurations.

The MAC Scell activation/deactivation command CE is also used interchangeably with Scell activation command in this disclosure for convenience.

Multiple options, embodiments and/or solutions are explained below.

Solution 1: Explicit Activation of Semi-Persistent (SP)-CSI Resource and SP-CSI Reporting Configuration

A first MAC Scell activation/deactivation command CE, generated by the activation/deactivation unit 32, is used for activating a serving cell. Two additional MAC CEs are used to activate a first semi-persistent CSI resource configuration and a first semi-persistent CSI reporting configuration. These MAC CEs are used to assist the early Scell activation mechanism indication. Once the network/network node 16 determines that the WD 22's serving cell is activated (e.g., via the CSI report based on the first semi-persistent CSI reporting), the network can send, via the radio interface 62, and/or cause, via processing circuitry 68, transmission of MAC CEs to deactivate the first semi-persistent CSI resource and the first semi-persistent CSI reporting configuration. The network/network node 16 can use its regular scheduling procedures, e.g., by activating a second CSI resource and/or second reporting configuration or use an aperiodic CSI resource and/or reporting to assist in scheduling for the serving cell. An activation command (e.g., an Scell activation command or semi-persistent CSI resource) can also trigger a CSI resource for tracking (or a tracking reference signal), which can also be deactivated using a corresponding deactivation command.

To assist with faster activation of the Scell, there may be one MAC CE command for Scell activation command, and four additional MAC CEs (for activation and deactivation) of semi-persistent CSI resource and CSI reporting configuration. Thus, at least five MAC command CEs may be needed.

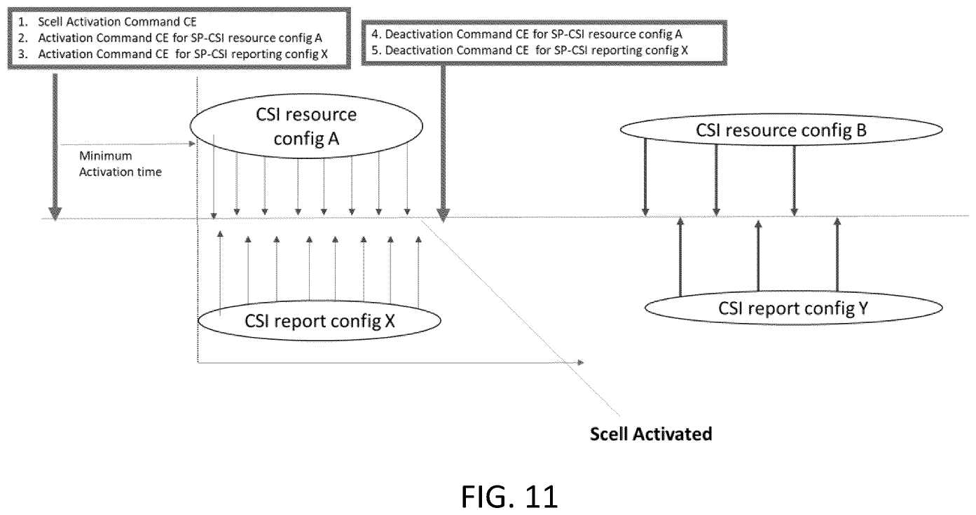

An example is shown in FIG. 11. CSI resource configuration A and CSI reporting configuration X may be used to assist faster activation of the Scell. CSI resource configuration B and CSI reporting configuration Y may be used for regular scheduling procedures with associated setup (not shown for convenience, but these can be periodic/aperiodic/semi-persistent).

An embodiment on the WD 22 side can be described as follows. The WD 22 receives, via radio interface 82, a first MAC Scell activation/deactivation command CE from the network node 16 indicating an activation command for a serving cell. The WD 22 receives, via the radio interface 82, MAC CE(s) activating a first semi-persistent CSI resource and a first semi-persistent CSI reporting configuration. The WD 22 sends, via the CSI reporting unit 34 and/or radio interface 82, a valid CSI based on the configured CSI resource and reporting, and in response, receives MAC CE(s) indicating deactivation of the first semi-persistent CSI resource and a first semi-persistent CSI reporting configuration, and deactivates the corresponding resource and reporting, in some embodiments.

In another embodiment, the WD 22 can be configured with a deactivation timer, implemented by processing circuitry 84, for a first semi-persistent CSI resource and a deactivation timer for a first semi-persistent CSI reporting configuration. When the first semi-persistent CSI resource and first semi-persistent CSI reporting configuration are activated, via the processing circuitry 84, the corresponding deactivation timers are started. If the deactivation timer expires, the first semi-persistent CSI resource and first semi-persistent CSI reporting configuration are deactivated, via the processing circuitry 84. If the deactivation timer is not expired and the WD 22 receives MAC CEs indicating deactivation of the first semi-persistent CSI resource and first semi-persistent CSI reporting configuration, the first semi-persistent CSI resource and first semi-persistent CSI reporting configuration are deactivated, in some embodiments.

These CSI resource and CSI reporting configurations are used to assist early Scell activation mechanism indication. The first semi-persistent CSI resource may be deactivated upon expiration of its deactivation timer or if a corresponding deactivation message (e.g., explicit MAC CE) is received. The first semi-persistent CSI reporting configuration may be deactivated upon expiration of its deactivation timer or if a corresponding deactivation message (e.g. explicit MAC CE) is received.

Solution 2: Implicit Activation of SP-CSI Resource and SP-CSI Reporting Configuration

In this solution, the WD 22 is configured with a first semi-persistent CSI resource and a first semi-persistent CSI reporting configuration for a serving cell, according to a decision by the activation/deactivation unit 32 of network node 16. A first MAC Scell activation/deactivation command CE is used for activating the serving cell. Upon reception of the Scell activation command, the first semi-persistent CSI resource and first semi-persistent CSI reporting configuration are also activated in an implicit manner (e.g., there are no additional separate MAC commands). These resources and configurations are used to assist the early Scell activation mechanism indication. Once the network determines that the WD 22's serving cell is activated (e.g., via the CSI report based on the first semi-persistent CSI reporting), the network/network node 16 can send and/or cause, via processing circuitry 68 and/or radio interface 62, transmission of MAC CEs to deactivate the first semi-persistent CSI resource and the first semi-persistent CSI reporting configuration. After Scell activation, the network/network node 16 can use its regular scheduling procedures, e.g., by activating a second CSI resource and/or second reporting configuration or use aperiodic CSI resource and/or reporting to assist the network's scheduling for the serving cell.

To assist with faster activation of the Scell, one MAC CE command may be used for the Scell activation command and the same MAC CE may be used for activation of semi-persistent CSI resource and CSI reporting configuration. Separate MAC CEs may be used for deactivation of the semi-persistent CSI resource and CSI reporting configuration. Thus, three MAC command CEs can be sufficient.

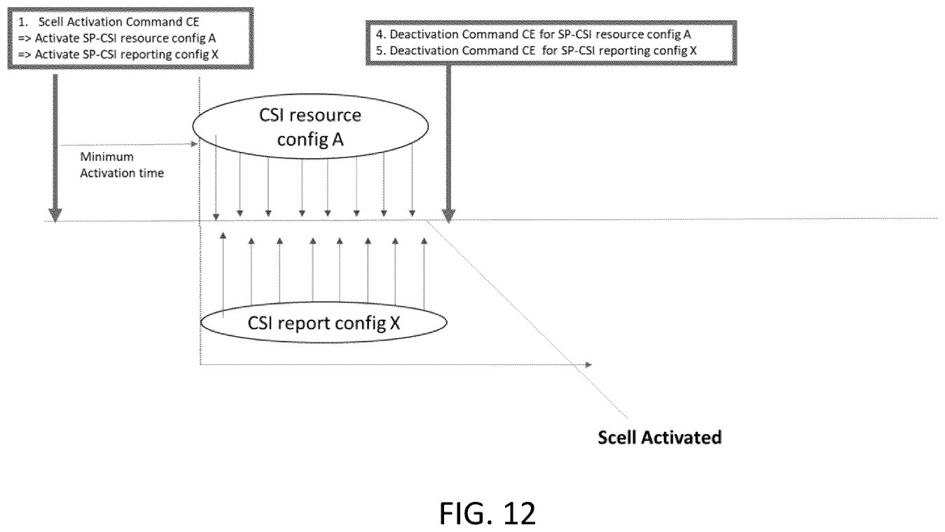

An example is shown in FIG. 12, CSI resource configuration A and CSI reporting configuration X are used to assist faster activation of the Scell. For simplicity, additional CSI resource configuration B and CSI reporting configuration Y, which can be used for regular scheduling procedures with associated setup commands, are not shown but may exist.

An embodiment of the WD 22 can be described as follows. The WD 22 may receive, via radio interface 82, a first MAC Scell activation/deactivation command CE indicating an activation command for a serving cell, and the first MAC CE implicitly activates a first semi-persistent CSI resource and a first semi-persistent CSI reporting configuration. The WD 22 may send, via radio interface 82, and/or cause, via processing circuitry 84, transmission of a valid CSI based on the configured CSI resource and reporting. In response, the WD 22 may receive, via radio interface 82, MAC CE(s) indicating deactivation of the first semi-persistent CSI resource and first semi-persistent CSI reporting configuration and the WD 22 deactivates the corresponding resource and reporting.

The WD 22 is configured with a first semi-persistent CSI resource and a first semi-persistent CSI reporting configuration. The WD 22 can be configured with a deactivation timer for a first semi-persistent CSI resource and a deactivation timer for a first semi-persistent CSI reporting configuration. A first MAC Scell activation/deactivation command CE may be used for activating a serving cell. Upon reception of this MAC Scell activation/deactivation Command CE, the first semi-persistent CSI resource and first semi-persistent CSI reporting configuration may also be activated, and the corresponding deactivation timers may be started. These CSI resources and CSI reporting configurations are used to assist the early Scell activation mechanism indication. The first semi-persistent CSI resource may be deactivated upon expiration of its deactivation timer or if a corresponding deactivation message (e.g., explicit MAC CE) is received. The first semi-persistent CSI reporting configuration may be deactivated upon expiration of the deactivation timer of the first semi-persistent CSI resource or if a corresponding deactivation message (e.g., explicit MAC CE) is received.

Typically, when the network/network node 16 determines that the WD's Scell is activated (e.g., via the CSI report based on the first semi-persistent CSI reporting), the network/network node 16 can send and/or cause, via radio interface 62 and/or processing circuitry 68, transmission of two MAC CEs to deactivate the first semi-persistent CSI resource and the first semi-persistent CSI reporting configuration or the network node can simply let the timer expire. The network/network node 16 can use its regular scheduling procedures after activation, e.g., by activating a second CSI resource and/or second reporting configuration or use aperiodic CSI resources and/or reporting to assist the network's scheduling for the serving cell.

To assist with faster activation of the Scell, one MAC CE command may be used for Scell activation commands and the same MAC CE may be used for activation of semi-persistent CSI resource and CSI reporting configuration and to start corresponding deactivation timers for the semi-persistent CSI resource and CSI reporting configuration. Separate MAC CEs or expiration of corresponding deactivation timers may be used for deactivation of the semi-persistent CSI resource and CSI reporting configuration. Thus, one MAC command CE can be sufficient to deactivate the SP CSI resource and CSI reporting configuration.

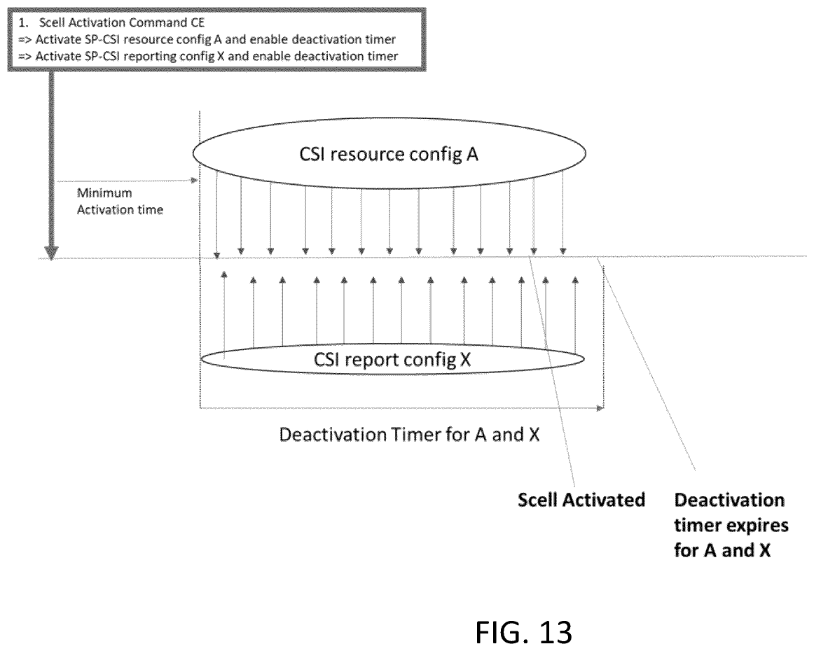

An example with timer expiration is shown in FIG. 13. CSI resource configuration A and CSI reporting configuration X are used to assist faster activation of the Scell. For simplicity, additional CSI resource configuration B and CSI reporting configuration Y, which can be used for regular scheduling procedures with associated setup commands, are not shown but may exist.

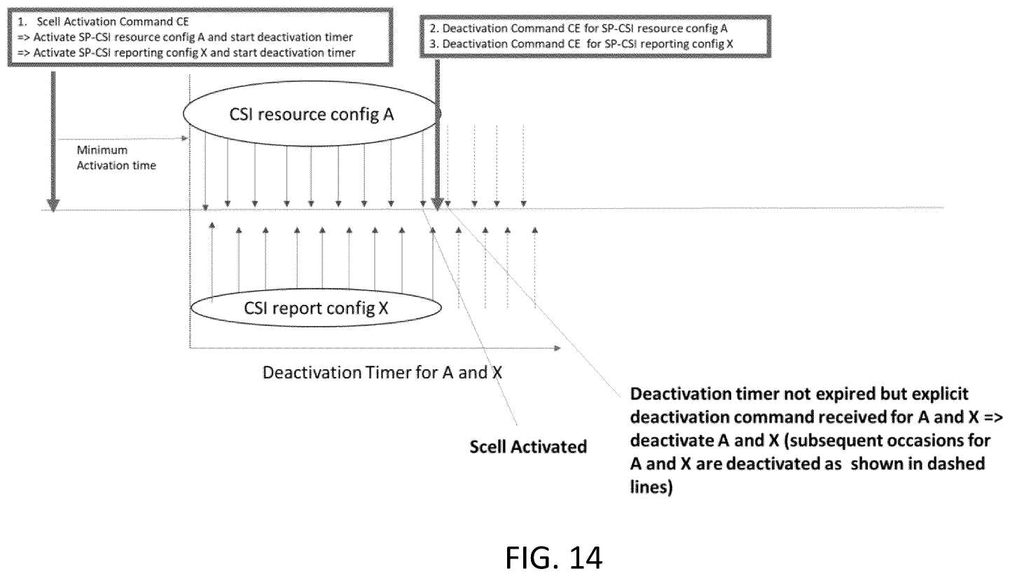

An example with explicit deactivation command received prior to timer expiration is shown in FIG. 14. For convenience, dashed arrows to the right of the deactivation command times are used to illustrate the remaining deactivated occasions of CSI resource configuration and CSI reporting config. CSI resource configuration A and CSI reporting configuration X are used to assist faster activation of the Scell. For simplicity, additional CSI resource configuration B and CSI reporting configuration Y, which can be used for regular scheduling procedures with associated setup commands, are not shown but may exist.

An embodiment of the WD 22 is described as follows. The WD 22 may receive a first MAC Scell activation/deactivation command CE indicating activation command for a serving cell, and the first MAC CE implicitly activates a first semi-persistent CSI resource and a first semi-persistent CSI reporting configuration. The WD 22 may send, via radio interface 82, and/or cause, via processing circuitry 84, transmission of a valid CSI based on the configured CSI resource and reporting. In response, the WD 22 may receive MAC CEs indicating deactivation of the first semi-persistent CSI resource and first semi-persistent CSI reporting configuration and the WD 22 may deactivate the corresponding resource and reporting.

In another embodiment, the WD 22 can be configured with a deactivation timer for a first semi-persistent CSI resource and a deactivation timer for first semi-persistent CSI reporting configuration. When the first semi-persistent CSI resource and first semi-persistent CSI reporting configuration are activated, the corresponding deactivation timers may be started. If a deactivation timer expires, the first semi-persistent CSI resource and first semi-persistent CSI reporting configuration may be deactivated. If the deactivation timer is not expired and the WD 22 receives MAC CE(s) indicating deactivation of the first semi-persistent CSI resource and first semi-persistent CSI reporting configuration, the first semi-persistent CSI resource and first semi-persistent CSI reporting configuration may be deactivated.

The following can apply to one or more of the above solutions. The Scell activation command can also include a transmission configuration indicator (TCI) state indication for the SP-CSI resources that are implicitly activated upon reception of the Scell activation command MAC CE. The TCI state indication can give QCL information for receiving the activated SP-CSI resources. Quasi co-location (QCL) information can be used for determining spatial parameters, e.g., beam, precoding, etc.

The activated SP-CSI resources can also include a total radiated sensitivity (TRS) resource that can be used by the WD 22 for time/frequency synchronization information for the serving cell. SP-CSI resources that are implicitly activated can be CSI resources with a pre-determined ID such as ID0 or can be explicitly configured. SP-CSI reporting configurations that are implicitly activated can be a CSI reporting configuration with a pre-determined ID such as ID0 or can be explicitly configured.

The Scell activation command can also include a TCI state indication for the physical downlink control channel (PDCCH) monitoring upon Scell activation. The TCI state indication can give QCL information for receiving the PDCCH on the Scell. QCL information can be used for determining spatial parameters, e.g. beam, precoding, etc.

The deactivation timer can be based on a maximum allowed activation delay. The deactivation timer can be based on one or more of the following: synchronization measurement timing configuration (SMTC), hybrid automatic repeat request (HARQ) timing (e.g., one-way or round-trip delay for HARQ), frequency range of the serving cell, SMTC periodicity, etc.

The first semi-persistent CSI resource and first semi-persistent CSI reporting configuration can be identified by inclusion of a flag identifying the association of the resource with an Scell activation command in the corresponding configuration. For example, in the CSI resource configuration, if a flag (e.g., “associated with Scell activation”) is set for a resource ID, then that resource ID is used during the activation procedure.

An example of the minimum and maximum Scell activation delay is described below for an example condition.

Minimum required activation delay is k1+3 ms+1 slots as specified in wireless communication standards such as in the Third Generation Partnership Project (3GPP) Technical Standard (TS) 38.213 subclause 4.3. Assuming 30 kHz numerology for the Pcell, and k1=4, this would be 5.5 ms.

Maximum allowed activation delay depends on conditions described in wireless communication standards such as in 3GPP TS 38.133 subclause 8.3.2 and the value varies based on the WD 22 measurement configuration, operating frequency range and other aspects.

```
  Assuming T_HARQ in 3GPP TS 8.133 has similar meaning as k1 in
3GPP TS 8.213, and assuming ‘known Scell’ with the Scell measurement
cycle is equal to or smaller than [160ms], and T_csi_reporting=4slots:
    For FR1 and 30kHz SCS:
      If SMTC periodicity 5ms, the delay cannot be larger than
    (T_HARQ= 4slots) + (T_act_time = 5ms+5ms) + (T_csi_report =
    4slots) = 14ms; and
      SMTC periodicity 20ms, the delay cannot be larger than
    (T_HARQ= 4slots) + (T_act_time = 5ms+20ms) +
    (T_csi_report = 4slots) = 29ms.
    For FR2, assuming this is the first Scell being activated in that FR2
  band:
      SMTC periodicity 5ms, the delay is
    4slots+5ms+TBD*5ms+4slots= 6ms+X*5ms;
      SMTC periodicity 20ms, the delay is
    4slots+5ms+TBD*20ms+4slots = 6ms+X*20ms; and
      X>1 is TBD in current Rel15 specs.
```

For other conditions, e.g., when Scell is not ‘known’ and with longer SMTC periodicities, the maximum allowed activation delay is much longer than the values in the above example.

Thus, according to one aspect, a network node 16 includes processing circuitry 68 configured to: determine if a serving cell of the WD 22 is activated; and cause transmission of at least one medium access control, MAC, control element, CE, to deactivate a first semi-persistent channel state information, CSI, resource and a first semi-persistent CSI reporting configuration.

According to this aspect, in some embodiments, the processing circuitry 68 is further configured to activate a second CSI resource and CSI reporting configuration. In some embodiments, the processing circuitry is further configured trigger a CSI resource or tracking reference signal.

According to another aspect, a WD 22 includes processing circuitry 68 configured to: receive at least one medium access control, MAC, control element, CE, from the network node 16 to activate a first semi-persistent channel state information, CSI, resource and a first semi-persistent CSI reporting configuration; and cause transmission of a valid CSI based on a configured CSI resource and report.

According to this aspect, in some embodiments, the processing circuitry 68 is further configured to receive a MAC CE indicating deactivation of the first CSI resource and reporting configuration. In some embodiments, the processing circuitry is further configured to deactivate the first CSI resource and reporting configuration.

According to one aspect, a network node 16 configured to communicate with a wireless device, WD 22, is provided. The network node 16 is configured to determine if a serving cell of the WD 22 is activated. The network node 16 is also configured to, when the serving cell of the WD 22 is activated, transmit at least one medium access control, MAC, control element, CE, to deactivate a first semi-persistent, SP, channel state information reference signal, CSI-RS, resource configuration and a first SP channel state information, CSI, reporting configuration.

According to this aspect, in some embodiments, the first SP CSI resource configuration and first SP CSI reporting configuration are configured by the WD 22 in response to at least one MAC CE different from the at least one MAC CE used to deactivate the first SP CSI-RS resource configuration and the SP CSI reporting configuration. In some embodiments, the network node 16, is further configured to activate a second SP CSI resource configuration and a second CSI reporting configuration. In some embodiments, the network node 16, is further configured to trigger a CSI resource or tracking reference signal. In some embodiments, the network node 16, is configured to transmit an activation command to the WD 22, the WD 22 being configured with multiple sets of CSI-RS, resource configurations and multiple sets of CSI reporting configurations, and the activation command specifying one of the multiple sets of CSI-RS resource configurations and one of the multiple sets of CSI reporting configurations. In some embodiments, the activation command triggers a CSI resource for tracking. In some embodiments, the activation command triggers the first CSI-RS resource configuration and the first CSI reporting configuration, implicitly. In some embodiments, the network node 16 is configured, upon activation, to use a first scheduling procedure to schedule at least an additional CSI-RS resource configuration and a CSI reporting configuration different from the first CSI-RS resource configuration and first CSI reporting configuration.

According to another aspect, a method implemented in a network node 16 includes determining if a serving cell of the WD 22 is activated, and when the service cell of the WD 22 is activated, transmitting at least one medium access control, MAC, control element, CE, to deactivate a first semi-persistent, SP, channel state information reference signal, CSI-RS, resource configuration and a first SP CSI reporting configuration.

According to this aspect, in some embodiments, the first SP CSI resource configuration and first SP CSI reporting configuration are configured by the WD 22 in response to the at least one MAC CE different from the at least one MAC CE used to deactivate the first SP CSI-RS resource configuration and the SP CSI reporting configuration. In some embodiments, the method further includes activating, via the processing circuitry 68, a second CSI-RS resource configuration and a second CSI reporting configuration. In some embodiments, the method further includes triggering, via the processing circuitry 68, a CSI resource or tracking reference signal. In some embodiments, the method further includes transmitting, via the radio interface 62, an activation command to the WD 22, the WD 22 being configured with multiple sets of CSI-RS, resource configurations and multiple sets of CSI reporting configurations, and the activation command specifying one of the multiple sets of CSI-RS resource configurations and one of the multiple sets of CSI reporting configurations. In some embodiments, the activation command triggers a CSI resource for tracking. In some embodiments, the activation command triggers the first CSI-RS resource configuration and the first CSI reporting configuration, implicitly. In some embodiments, the method further includes using, via the processing circuitry 68, a first scheduling procedure to schedule at least an additional CSI-RS resource configuration and a CSI reporting configuration different from the first CSI-RS resource configuration and first CSI reporting configuration, respectively.

According to yet another aspect, a WD 22 configured to communicate with a network node 16 is provided. The WD 22 is configured to receive at least one medium access control, MAC, control element, CE, from the network node 16 to activate a first semi-persistent channel state information reference signal, SP CSI-RS, resource configuration and a first SP channel state information, CSI, reporting configuration. The WD 22 is also configured to cause transmission of a valid CSI based at least in part on a configured CSI resource and report responsive to the at least one MAC CE.

According to this aspect, in some embodiments, the WD 22 is further configured to receive a MAC CE indicating deactivation of the first SP CSI-RS resource and the SP CSI reporting configuration. In some embodiments, the WD 22 is further configured to deactivate the first SP CSI-RS resource and the first SP CSI reporting configuration upon receiving the MAC CE indicating deactivation. In some embodiments, the WD 22 is further configured to implement a deactivation timer to deactivate the first SP CSI-RS resource configuration and the first SP CSI reporting configuration when the deactivation timer expires. In some embodiments, deactivation occurs if a deactivation command is received from the network node 16 when the deactivation timer has not expired.

According to yet another aspect, a method implemented in a wireless device (WD 22) includes receiving, via the radio interface 82, at least one medium access control, MAC, control element, CE, from the network node 16 to activate a first semi-persistent channel state information reference signal, SP CSI-RS, resource configuration and a first SP channel state information, CSI, reporting configuration. The method also includes causing, via the processing circuitry 84 and/or radio interface 82, transmission of a valid CSI based at least in part on a configured CSI resource and report responsive to the at least one MAC CE.

According to this aspect, in some embodiments, the method further includes receiving a MAC CE indicating deactivation of the first CSI resource and the SP CSI reporting configuration. In some embodiments, the method includes deactivating the first CSI resource and reporting configuration upon receiving the MAC CE indicating deactivation. In some embodiments, the method includes implementing a deactivation timer to deactivate the first SP CSI-RS resource configuration and the first SP CSI reporting configuration when the deactivation timer expires. In some embodiments, deactivation occurs if a deactivation command is received from the network node 16 when the deactivation timer has not expired.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### ABBREVIATION EXPLANATION

CQI Channel Quality Information

SS-block Synchronization Signal Block

DC Dual-connectivity

DCI Downlink Control Information

DFT Discrete Fourier Transform

DM-RS Demodulation Reference Signal

FDM Frequency Division Multiplex

HARQ Hybrid Automatic Repeat Request

OFDM Orthogonal Frequency Division Multiplex

PAPR Peak to Average Power Ratio

PBCH Primary Broadcast Channel

PRACH Physical Random Access Channel

PRB Physical Resource Block

PUCCH Physical Uplink Control Channel

PUSCH Physical Uplink Shared Channel

RRC Radio Resource Control

SRS Sounding Reference Signal

SS-block Synchronization Signal Block

TCI Transmission Configuration Information

UCI Uplink Control Information

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node configured to determine if a serving cell of the WD is activated; and
when the serving cell of the WD is activated, transmit at least one medium access control, MAC, control element, CE, to deactivate a first semi-persistent, SP, channel state information reference signal, CSI-RS, resource configuration and a first SP channel state information, CSI, reporting configuration.

2. The network node of claim 1, wherein the first SP CSI resource configuration and first SP CSI reporting configuration are configured by the WD in response to at least one MAC CE different from the at least one MAC CE used to deactivate the first SP CSI-RS resource configuration and the SP CSI reporting configuration.

3. The network node of claim 1, wherein the network node is further configured to activate a second SP CSI resource configuration and a second CSI reporting configuration.

4. The network node of claim 1, wherein the network node is further configured to trigger one of a CSI resource and a tracking reference signal.

5. The network node of claim 1, wherein the network node is configured to transmit an activation command to the WD, the WD being configured with multiple sets of CSI-RS, resource configurations and multiple sets of CSI reporting configurations, and the activation command specifying one of the multiple sets of CSI-RS resource configurations and one of the multiple sets of CSI reporting configurations.

6. The network node of claim 5, wherein the activation command triggers a CSI resource for tracking.

7. (canceled)

8. (canceled)

9. A method implemented in a network node, the method comprising:
determining if a serving cell of the WD is activated; and
when the service cell of the WD is activated, transmitting at least one medium access control, MAC, control element, CE, to deactivate a first semi-persistent, SP, channel state information reference signal, CSI-RS, resource configuration and a first SP CSI reporting configuration.

10. The method of claim 9, wherein the first SP CSI resource configuration and first SP CSI reporting configuration are configured by the WD in response to the at least one MAC CE different from the at least one MAC CE used to deactivate the first SP CSI-RS resource configuration and the SP CSI reporting configuration.

11. The method of claim 9, further comprising activating a second CSI-RS resource configuration and a second CSI reporting configuration.

12. The method of claim 9, further comprising triggering one of a CSI resource and a tracking reference signal.

13. The method of claim 9, further comprising transmitting an activation command to the WD, the WD being configured with multiple sets of CSI-RS, resource configurations and multiple sets of CSI reporting configurations, and the activation command specifying one of the multiple sets of CSI-RS resource configurations and one of the multiple sets of CSI reporting configurations.

14. The method of claim 13, wherein the activation command triggers a CSI resource for tracking.

15. (canceled)

16. (canceled)

17. A wireless device, WD, configured to communicate with a network node, the WD configured to:
receive at least one medium access control, MAC, control element, CE, from the network node to activate a first semi-persistent channel state information reference signal, SP CSI-RS, resource configuration and a first SP channel state information, CSI, reporting configuration; and
cause transmission of a valid CSI based at least in part on a configured CSI resource and report responsive to the at least one MAC CE.

18. The WD of claim 17, wherein the WD is further configured to receive a MAC CE indicating deactivation of the first SP CSI-RS resource and the SP CSI reporting configuration.

19. The WD of claim 18, wherein the processing circuitry is further configured to deactivate the first SP CSI-RS resource and the first SP CSI reporting configuration upon receiving the MAC CE indicating deactivation.

20. The WD of claim 17, wherein the WD is further configured to implement a deactivation timer to deactivate the first SP CSI-RS resource configuration and the first SP CSI reporting configuration when the deactivation timer expires.

21. (canceled)

22. A method implemented in a wireless device (WD), the method comprising:
receiving at least one medium access control, MAC, control element, CE, from the network node to activate a first semi-persistent channel state information reference signal, SP CSI-RS, resource configuration and a first SP channel state information, CSI, reporting configuration; and
causing transmission of a valid CSI based at least in part on a configured CSI resource and report responsive to the at least one MAC CE.

23. The method of claim 22, further comprising receiving a MAC CE indicating deactivation of the first CSI resource and the SP CSI reporting configuration.

24. The method of claim 23, further comprising deactivating the first CSI resource and reporting configuration upon receiving the MAC CE indicating deactivation.

25. The method of claim 22, further comprising implementing a deactivation timer to deactivate the first SP CSI-RS resource configuration and the first SP CSI reporting configuration when the deactivation timer expires.

26. (canceled)
